(19) United States
(12) Patent Application Publication
(10) Pub. No.: US 2014/0173111 A1
(43) Pub. Date: Jun. 19, 2014

(54) DATA USAGE MANAGEMENT SYSTEMS AND METHODS

(71) Applicant: NETZERO WIRELESS, INC., Woodland Hills, CA (US)

(72) Inventor: Curtis Varner, Oak Park, CA (US)

(73) Assignee: NETZERO WIRELESS, INC., Woodland Hills, CA (US)

(21) Appl. No.: 13/831,123

(22) Filed: Mar. 14, 2013

Related U.S. Application Data
(60) Provisional application No. 61/739,651, filed on Dec. 19, 2012.

(51) Int. Cl. H04L 12/24

(52) U.S. Cl. CPC H04L 41/00
USPC 709/225

(57) ABSTRACT

Systems and methods allow network users to manage their data usage. Various systems and methods are particularly aimed at users of metered data networks that require users to pay based on data usage, and allow for preventing or controlling data usage, so as to assist users in staying within a budget. Some systems and methods provide users with a way to prevent or throttle background data usage that they might not otherwise be aware of, such as background updates by applications that require the downloading of data. Also, some systems and methods allow for the use of compression and/or degradation to reduce data usage, and for the presentation of usage statistics to users to allow users to make more informed data usage decisions.

### CROSS-REFERENCE TO RELATED PATENT APPLICATIONS

This application claims the benefit of U.S. Provisional Patent App. Ser. No. 61/739,651, filed Dec. 19, 2012, incorporated herein by reference in its entirety.

### BACKGROUND INFORMATION

1. Field of the Invention

Embodiments of the present invention relate generally to systems and methods for data usage management and, in particular embodiments, to systems and methods that allow network users to manage their network data usage.

2. Related Art

Traffic on data communication networks, such as the Internet, and especially on wireless communication networks has been growing rapidly in recent years. The growth in data usage has been driven by technological advances, such as improvements in wireless network connectivity and speed for mobile devices, and improvements in the ability to stream video. Due to increased data usage by customers, many network operators and Internet service providers have started to replace unlimited data plans with data plans having prices based on consumption. Such metered data plans with usage-based pricing or tiered pricing reflect the idea that users should pay for the amount of data that they use. As a growing number of network providers impose data usage limits and fees on customers, the days of largely all-you-can-eat data plans may be coming to an end.

### SUMMARY OF THE DISCLOSURE

Systems and methods in accordance with various embodiments allow network users to manage their data usage. Various embodiments are particularly aimed at users of metered data networks that require users to pay based on data usage, and such embodiments allow for preventing or controlling data usage, so as to assist users in staying within a budget. Some embodiments provide users with a way to prevent or throttle background data usage that they might not otherwise be aware of, such as background updates by applications that require the downloading of data. Also, some embodiments allow for the use of compression and/or degradation to reduce data usage, and for the presentation of usage statistics to users to allow users to make more informed data usage decisions.

Various embodiments provide for a clientless approach for preventing background updates. Such embodiments use Domain Name System (DNS) servers that are specially configured to blackhole (or route to a different Internet Protocol (IP) address) traffic that is destined for hosts that are predominately used by applications for background updates, such as hostnames used by Microsoft's Windows® update, Symantec's Norton Anti-Virus® update, or the like. In some embodiments, a user device is provided with an IP address for at least one of the specially configured DNS servers by a network provider server when the user device connects to the network provider. In some embodiments, depending on one or more user settings prior to connection to a network, the user device's connection to the network is assigned to one of a plurality of DNS servers, where the assigned DNS server can be either a specially configured DNS server that blackholes specified hosts or domains, or can be a DNS server that does not blackhole anything. In the case where the user device is assigned to a specially configured DNS server, the user device then sends DNS queries for hostnames to the specially configured DNS server, and the DNS server checks the hostnames against a blacklist of hostnames that are well known as hostnames used for background updates. If a hostname is on the blacklist, then the specially configured DNS server returns an IP address of a specially configured server in response to the DNS query from the user device. The specially configured server is configured such that when the user device sends a request to the server, the server rejects the request from the user device, which prevents the background update from occurring.

Various embodiments involve installing a client/agent program on the user device. The client program allows for finer grained control of background downloads, such as (i) giving the user control of permitting or blocking based on domain; (ii) prompting a user at each occurrence for confirmation (and showing previous usage with the site attempting to be contacted for guessing how much data might be used if the connection is accepted); and/or (iii) enabling all connections and background downloads for network types and names that are on a whitelist (e.g., allowing background downloads when connected to wired networks and/or specific 802.11 networks). In some embodiments, permitted background connections are throttled by the client program rather than being blocked, so that they can proceed but at a reduced data rate. The client program may also be configured to allow for inactivity based throttling or chocking-off of networks, such as throttling when there has been no user interaction with the user device for some period of time.

In some embodiments, the client program on the user device is configured to communicate with a server proxy on a server over a network. Such a configuration allows for compressing data and/or degrading images and video to lessen actual data usage. Such a configuration may also be used to provide security by encrypting traffic where possible. Statistics, such as per-site data usage statistics per device, may also be uploaded and made visible on a customer account management website and reported per device. Other statistics may also be maintained and uploaded, such as per-MIME-type data usage statistics (e.g., text, mail, images, video) for review on the account management website with original and transferred sizes reported so that a user could determine data usage and savings. Various configurations and architectures in accordance with various embodiments provide for the gathering of statistical information about data, and for prioritization and reduction of data, for the purposes of reducing or minimizing an amount of data transiting a wireless portion of a network connection, rather than for just reducing a user perceived response time. Various reports on the account management website also allow a user to see at a glance and to click for more detail about how much data over a specified time/date range has been used and reduced from an original size through compression and/or degradation, as well as by MIME type, site/domain, and/or network connection type.

### BRIEF DESCRIPTION OF THE DRAWINGS

FIG. 1 is a system in accordance with an embodiment that allows for data usage management;

FIG. 2 is a portion of the system of FIG. 1 and shows examples of types of wireless devices that can be used in accordance with various embodiments;

FIG. 3A is a flowchart of a method in accordance with an embodiment that allows for blocking background updates by applications on a user device using a specially configured DNS server;

FIG. 3B is a continuation of the flowchart of FIG. 3A;

FIG. 3C is a continuation of the flowchart of FIGS. 3A and 3B;

FIG. 4 is diagram of a system in accordance with an embodiment with a local proxy program on a user device and a server proxy program on a server of a mobile virtual network operator;

FIG. 5A is a flowchart of a method in accordance with an embodiment that uses a local proxy on a user device to enable or block connections to specified domains;

FIG. 5B is a continuation of the flowchart of FIG. 5A;

FIG. 5C is a continuation of the flowchart of FIGS. 5A and 5B;

FIG. 6A is a flowchart of a method in accordance with an embodiment that uses a local proxy on a user device and a server proxy to enable or block connections to specified domains;

FIG. 6B is a continuation of the flowchart of FIG. 6A;

FIG. 6C is a method of determining in accordance with an embodiment that can be used in a decision step of FIG. 6B;

FIG. 7A is a method of throttling communications by a local proxy that can be used rather than blocking communications in various embodiments;

FIG. 7B is a method of throttling communications by a server proxy that can be used rather than blocking communications in various embodiments;

FIG. 7C is a flowchart of a method in accordance with an embodiment for throttling communications by a proxy;

FIG. 8 is a flowchart of a method in accordance with an embodiment for determining whether a network connection request is for a background update for an application;

FIG. 9A is a flowchart of a method for degrading, compressing, and/or encrypting data by a server proxy to be provided to a local proxy and for reporting statistics related to the data;

FIG. 9B is a continuation of the flowchart of FIG. 9A;

FIG. 10A is a flowchart of a method in accordance with an embodiment that allows for blocking background updates using a suffix in a default domain search list;

FIG. 10B is a continuation of the flowchart of FIG. 10A;

FIG. 11A is a flowchart of a method in accordance with an embodiment that allows for blocking background updates using a mapping from a user device IP address to user settings in a database;

FIG. 11B is a continuation of the flowchart of FIG. 11A;

FIG. 12 is a block diagram of a computing system with a display and input device that is connected to a communications network in accordance with an embodiment.

### DETAILED DESCRIPTION OF PREFERRED EMBODIMENTS

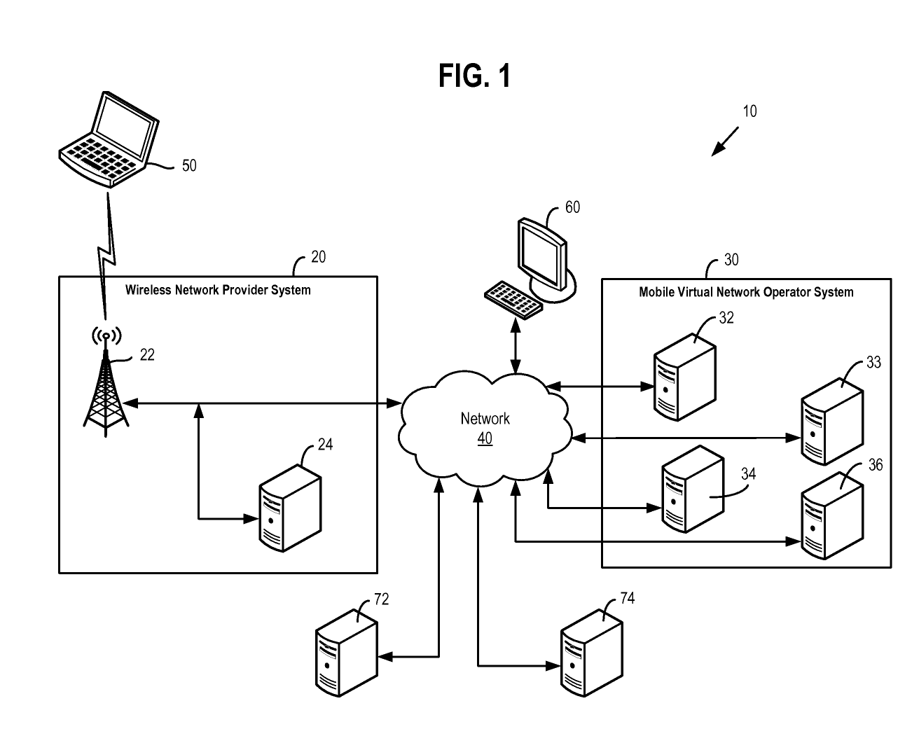

FIG. 1 is a computer-implemented data processing system 10 in accordance with an embodiment. The system 10 includes a wireless network provider system 20, a Mobile Virtual Network Operator (MVNO) system 30, a network 40, a user device 50, an access device 60, an update server 72, and an update server 74. The wireless network provider system 20 includes a base station 22 and a wireless network provider server 24. The MVNO system 30 includes an account management web server 32, a Domain Name System (DNS) server 33, a special DNS server 34, and a special server 36. In some other embodiments, the DNS server 33 is in the wireless network provider system 20 rather than in the MVNO system 30. The user device 50, access device 60, update server 72, update server 74, base station 22, wireless network provider server 24, account management web server 32, DNS server 33, special DNS server 34, and special server 36 may each comprise a computing system (e.g., one or more processors) configured to execute instructions, send and receive data stored in non-transitory storage mediums (memory), and perform other operations to implement the operations described herein associated with methods shown in the Figures.

The user device 50 may comprise, for example, a wireless mobile computing device that includes at least one wireless antenna that communicates with the wireless network provider system 20. In some embodiments, the user device 50 includes at least one wireless antenna that communicates with one or more other wireless mobile computing devices. In such embodiments, the user device 50 may act as a wireless or wired router to one or more wireless mobile computing devices and may allow the wireless mobile computing devices to communicate with the wireless network provider system 20. In yet another embodiment, the user device 50 may communicate with one or more mobile computing devices via a Wi-Fi, Near Field Communication (NFC), and/or Bluetooth protocol. In some embodiments, the user device 50 may have a Universal Serial Bus (USB) connector that connects to a USB connector of a wireless mobile computing device. A wireless mobile computing device could be, for example, a desktop, laptop, tablet Personal Computer (PC), tablet, mobile telephone, smart phone, and so on. In some embodiments, the user device 50 may communicate with a computing device via a USB connection and communicate wirelessly with the wireless network provider system 20. In some embodiments, the user device 50 may communicate with some computing devices via a wireless link and with other computing devices thought wired (Category (CAT) 5, USB, and/or Thunderbolt) cables. In various embodiments, the user device 50 can receive power from at least one of a battery, in-wall power outlet, USB connector, or inductive power transfer to a battery.

The user device 50 may be used by an individual user (e.g., a business owner or employee, a consumer, and so on) to interact with the wireless network provider system 20, the network 40, the MVNO system 30, the update server 72, and/or the update server 74. The user device 50 may, for example, be a cellular phone, smart phone, mobile handheld wireless e-mail device, personal digital assistant, portable gaming device, router, or other suitable device. The user device 50 may include a network interface device, a display device (e.g., Liquid Crystal Display (LCD) screen, Light Emitting Diodes (LEDs), indicator lights, or the like), an input device (e.g., keyboard, mouse, buttons and/or switches and so on), and a storage medium. In some embodiments, the user device 50 is a computing device with a processor coupled to a machine readable storage medium. In some embodiments, the user device 50 may have a wireless antenna that is configured to communicate using at least one of a WiMax (IEEE 802.16), 2G, HSPA™, HSPA+™, 802.11a-802.11z™, 3G™, LTE™, or 4G™ protocol and/or other wireless protocols. The user device 50 may be configured to communicate with the base station 22 that can communicate with the network 40.

The wireless network provider system 20 may include various systems and computers. In some embodiments, the wireless network provider system 20 includes the base station 22 and the wireless network provider server 24. In some embodiments, the base station 22 and the wireless network provider server 24 are implemented on a single unitary computer system. Alternatively, the base station 22 and the wireless network provider server 24 can each be implemented on a plurality of distributed computer systems that are connected with each other. Additionally or alternatively, the base station 22 and the wireless network provider server 24 may be remotely located (e.g. in different buildings or cities) from each other and receive power from different power outlets. In some embodiments, the base station 22 can connect through a proprietary wired system with the wireless network provider server 24.

The base station 22 includes one or more antennas that are capable of communicating wirelessly with various different types of mobile devices, such as the user device 50. The base station 22 also communicates with various components of the wireless network provider system 20. Additionally, the base station 22 is configured to communicate with the network 40 and possibly other proprietary or public networks. In some embodiments, the base station 22 communicates data to and from the user device 50 and to and from the network 40. In some embodiments, the user device 50 and the base station 22 work together to act as an intermediary between a computing device and the network 40.

The network 40 may comprise a local area network (LAN), a wide area network (WAN), a wired or wireless network, the Internet, and/or a combination thereof. The network 40 transfers data between a plurality of systems, such as but not limited to, the user device 50, the wireless network provider system 20, the MVNO system 30, the access device 60, the update server 72, the update server 74, and other systems.

The MVNO system 30 may include a plurality of computer systems and network connections. The MVNO system 30 includes the account management web server 32, the special DNS server 34, and the special server 36. In some embodiments, the account management web server 32, the special DNS server 34, and the special server 36 are implemented on a single unitary computer system. Alternatively, the account management web server 32, the special DNS server 34, and the special server 36 can each be implemented on a plurality of connected computer systems. Additionally or alternatively, the account management web server 32, the special DNS server 34, and the special server 36 can be individual computing systems that are remotely located (e.g. in different buildings or cities) from each other and receive power from different power outlets. In some embodiments, the account management web server 32, the special DNS server 34, and the special server 36 are connected with each other through a proprietary wired system and can also communicate with the network 40.

The account management web server 32 is a web server that provides account management controls to account administrators and to users, such as a user of the access device 60 and the user device 50. In some embodiments, the account management web server 32 generates various web pages that allow the user to change settings relating to how communications from the user device 50 should be handled by the wireless network provider system 20 and/or the MVNO system 30. Also, in some embodiments, the account management web server 32 generates statistical and other types of reports that can be sent to the user device 50 and/or access device 60 for display in a web browser or the like.

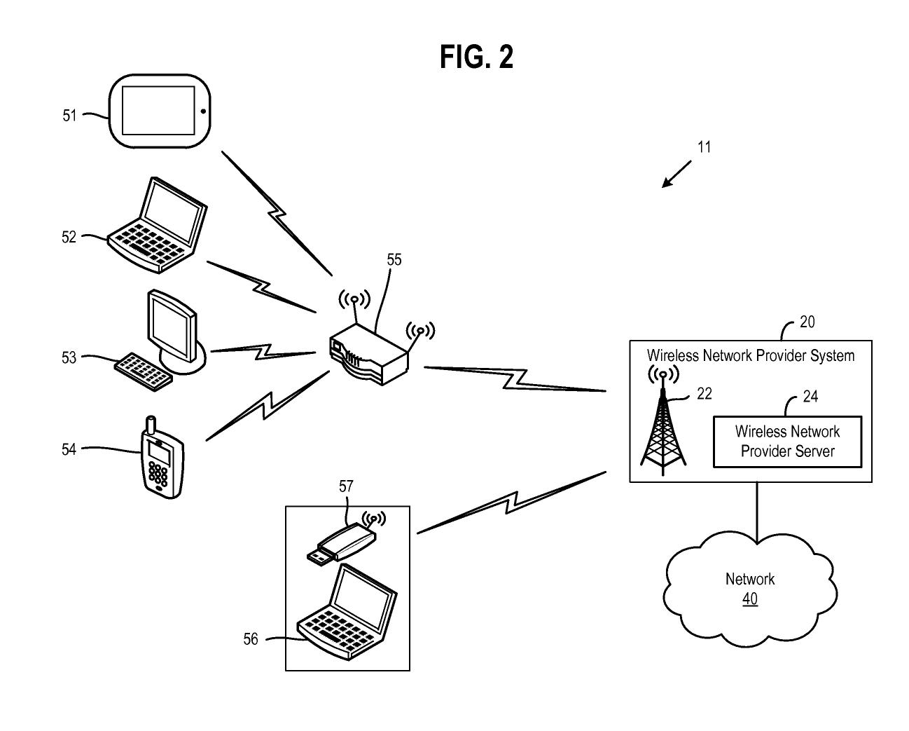

FIG. 2 illustrates a portion 11 of the system 10 of FIG. 1 in accordance with an example embodiment. Various example devices that could be used as the user device 50 of FIG. 1 are shown in FIG. 2, such as a tablet 51, a laptop computer 52, a desktop computer 53, a smart phone 54, a wireless router 55, and/or a laptop computer 56 with a wireless USB device 57. The wireless router 55 is configured to communicate with the base station 22 of the wireless network provider system 20. In various embodiments, the wireless router 55 is designed with one or more antennas, which are capable of providing communication with the tablet 51, the laptop computer 52, the desktop computer 53, and the smart phone 54. The wireless USB device 57 may be connected to the laptop computer 56, and the laptop computer 56 may provide the power needed for the wireless USB device 57. The wireless USB device 57 is configured to communicate with the base station 22 of the wireless network provider system 20. In various embodiments, the wireless network provider server 24 assigns Internet Protocol (IP) addresses to devices such as the tablet 51, the laptop computer 52, the desktop computer 53, the smart phone 54, and the laptop computer 56 when they request access to the network 40.

Referring again to FIG. 1, in various embodiments, the user device 50 runs applications, such as web browsers, games, document processing programs, spreadsheet programs, map programs, and/or the like, that are configured to periodically check for updates for themselves with update servers, such as the update server 72 and the update server 74. The checking for updates by applications may run in the background and, in some cases, a user is not notified of such background updates. The applications may update themselves by installing the background updates. Each application on the user device 50 may store a hostname of a corresponding update server from which the application is to receive background updates. For example, a Microsoft® application may store a hostname within the windowsupdate.com domain for an update server from which the application can receive background updates.

Various embodiments disclosed herein allow for wireless network users to manage their data usage. In some embodiments, background downloads for background updates may be prevented, which gives the user a way to prevent background data usage that they may or may not otherwise be aware of. Some embodiments may be particularly aimed at users of metered networks in which users pay according to an amount of data consumption, and the embodiments can help to reduce an amount of data downloaded so as to reduce an amount of money owed by a user. Various embodiments use servers in the MVNO system 30 to prevent the background downloads, because it might not be feasible for the MVNO to put network equipment into the wireless network provider system 20 or software onto the user device 50. In other embodiments, the MVNO might be able to install client software on the user device 50, in which case the user device 50 could also be controlled to prevent background downloads for background updates. Also, in some embodiments, the MVNO is able to install network equipment into the wireless network provider system 20 to control background downloads for background updates. In various embodiments, a clientless approach makes use of DNS servers that are specially configured to blackhole (or route to a different IP address) traffic that is destined for hosts that are predominately used by applications for background updates (such as the hostnames used by Microsoft's Windows® update or Symantec's Norton Anti-Virus® update). Such embodiments use special DNS servers to blackhole well known destinations that are related to software updates, so as to reduce the data traffic due to background downloads.

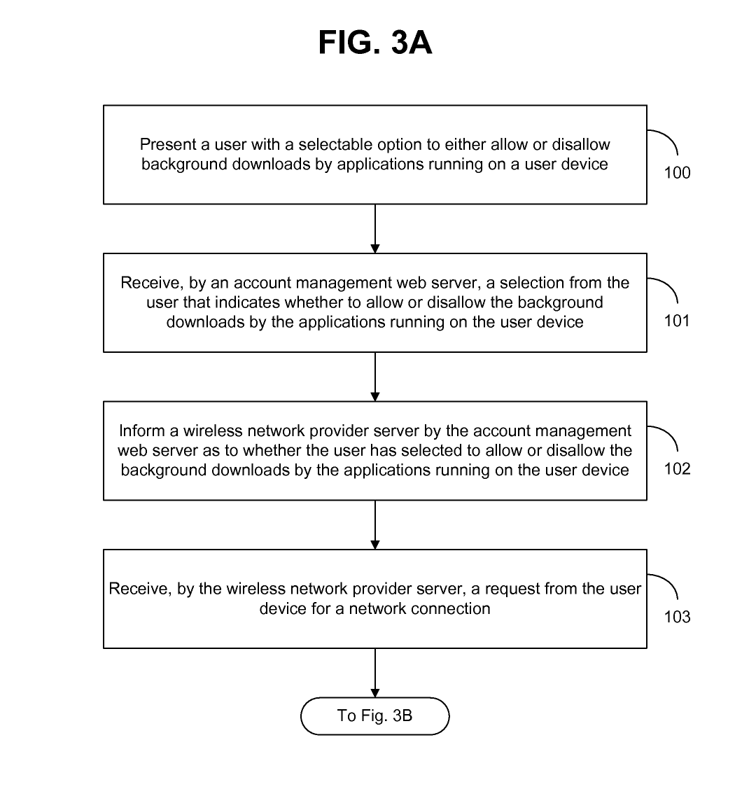

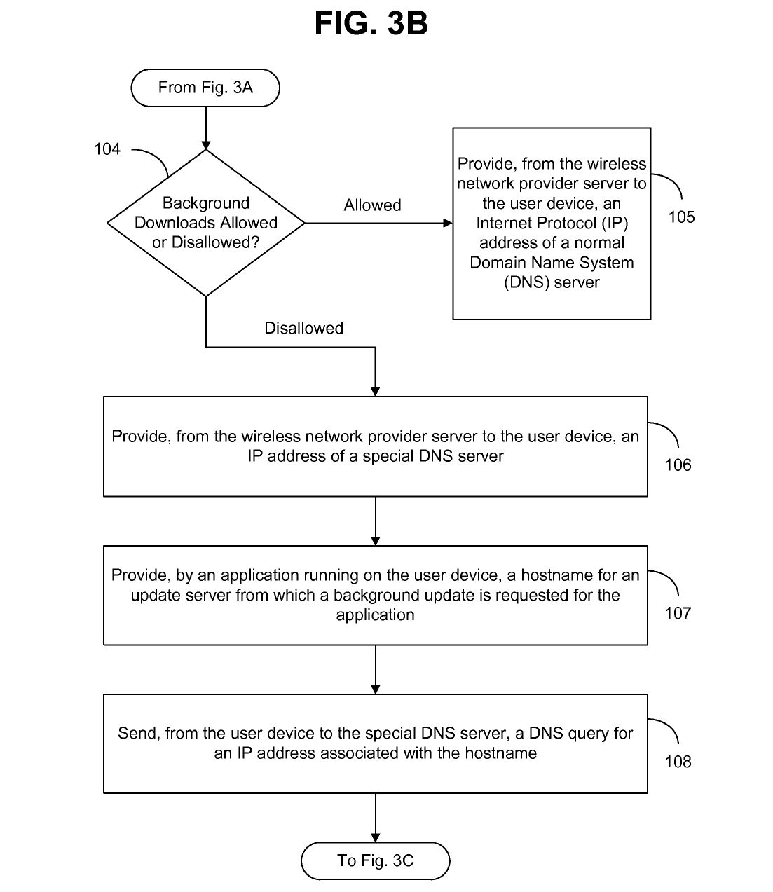

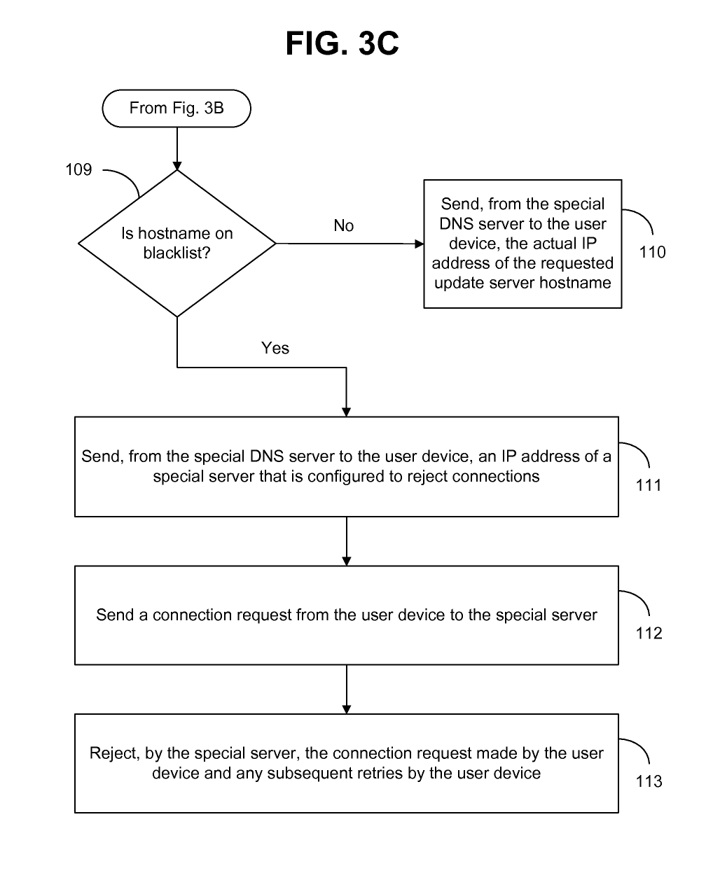

FIGS. 3A, 3B, and 3C are a flowchart of a method in accordance with an embodiment that allows for blocking background updates by applications on a user device using a specially configured DNS server. With reference to FIGS. 1 and 3A-3C, in step 100 the user is presented with a selectable option to either allow or disallow background downloads by applications running on the user device 50. For example, the user may log into the account management web server 32 from the user device 50 and/or the access device 60, and the account management web server 32 provides a web page for display in a web browser that allows a user to select between allowing background downloads for background updates or disallowing background downloads for background updates. The method then continues to step 101. In step 101, the account management web server 32 receives a selection from the user that indicates whether to allow or disallow the background downloads by the applications running on the user device 50. For example, the user may make a selection in a web page using the user device 50 and/or the access device 60, and then the selection may be sent back to the account management web server 32. The method then continues to step 102.

In step 102, the account management web server 32 informs the wireless network provider server 24 as to whether the user has selected to allow or disallow the background downloads by the applications running on the user device. The account management web server 32 may send such information to the wireless network provider server 24 over the network 40. The method then continues to step 103. In step 103, the wireless network provider server 24 receives a request from the user device 50 for a network connection to use the network 40. The user device 50 may communicate with the wireless network provider server 24 through the base station 22. The method then continues to step 104.

In step 104, the wireless network provider server 24 determines whether background downloads are allowed or disallowed for the user device 50 based on the information regarding the selection previously made by the user that the wireless network provider server 24 received from the account management web server 32. If it is determined in step 104 that background downloads are allowed for the user device 50, then the method continues to step 105. In step 105, the wireless network provider server 24 provides the user device 50 with an IP address of a normal DNS server. In such a case, when an application running on the user device 50 requests a background download, the hostname for the corresponding update server, such as the update server 72 or the update server 74, is sent from the user device 50 to the normal DNS server, and the normal DNS server returns an actual IP address for the update server. The application on the user device 50 can then use the actual IP address for the update server to access the update server and receive the background update over the network 40.

On the other hand, if it is determined in step 104 that background downloads are disallowed for the user device 50, then the method continues to step 106. In step 106, the wireless network provider server 24 provides the user device 50 an IP address of the special DNS server 34. The method then continues to step 107. In step 107, an application running on the user device 50 provides a hostname for an update server, such as the update server 72 or the update server 74, from which a background update is requested for the application. The method then continues to step 108. In step 108, the user device 50 sends to the special DNS server 34 a DNS query for an IP address associated with the hostname of the update server requested by the application. The user device 50 may communicate with the special DNS server 34 through the base station 22 and the network 40. The method then continues to step 109.

The special DNS server 34 maintains in storage a blacklist of hostnames/domainname suffixes that correspond to update servers known to be used predominately by applications for background updates (such as the hostnames used by Microsoft's Windows® update or Symantec's Norton Anti-Virus® update). In step 109, the special DNS server 34 determines whether the hostname received in the DNS query from the user device 50 is on the blacklist maintained by the special DNS server 34. If it is determined in step 109 that the hostname is not on the blacklist, then the method continues to step 110. In step 110, the special DNS server 34 sends to the user device 50, the actual IP address of the update server, such as the update server 72 or the update server 74, associated with the hostname from which the application can receive the background update. The user device 50 can then use the IP address of the update server to communicate with the update server to receive the background update. On the other hand, if it is determined in step 109 that the hostname received in the DNS query is on the blacklist, then the method continues to step 111.

In step 111, the special DNS server 34 sends to the user device 50 an IP address of the special server 36 that is configured to reject connections. In some embodiments there are multiple possible special server IP addresses (irrespective of whether there are multiple physical servers that act as special servers or just a single physical server that acts as a special server) to allow for customized rejection behavior by inference of what hostname/domain was originally requested. In some such embodiments, the special DNS server 34 selects an IP address from among the multiple possible special server IP addresses to send to the user device 50 based at least partially on a hostname or domain that was originally requested by the user device 50. The method then continues to step 112. In step 112, the user device 50 sends a connection request to the special server 36 in an attempt to obtain a background update. The method then continues to step 113. In step 113, the special server 36 rejects the connection request made by the user device 50 and also rejects any subsequent retries by the user device 50. In such a case, the user device 50 does not receive the background update, so the amount of data consumed by the user is reduced. In some embodiments, the rejection of the connection by the special server 36 is customized based on the originally requested domainname. Some possible forms of rejections may be (a) active rejection in which a rejection message is returned to the user device 50; or (b) passive rejection where packets are dropped either before or immediately after a connection is established in order to slow down connection retry rates. Actively rejecting connections may cause some applications to repeatedly try to connect, which could waste data due to the repeated connections attempts, so in some cases it may be beneficial to use passive rejection to slow down connection retry rates.

In various embodiments, there are two possible user selectable settings for background downloads such as “allow background downloads” or “do not allow background downloads”. When the user device 50 of the user attempts to connect to the network 40, the wireless network provider server 24 provides an IP address of a DNS server to the user device 50. If the background downloads are allowed, then the wireless network provider server 24 provides an IP address of a normal DNS server to the user device 50. The normal DNS server does not lie about IP addresses for hostnames, so when the user device 50 provides a DNS query with a hostname for an update server to the normal DNS server, the normal DNS server returns the actual IP address of the update server, and the user device 50 can use the IP address to communicate with the update server to receive the background update. On the other hand, if the background downloads are disallowed, then the wireless network provider server 24 provides an IP address of the special DNS server 34 to the user device 50. When the user device 50 provides a DNS query with a hostname for an update server to the special DNS server 34, the special DNS server 34 returns an IP address of the special server 36 rather than the actual IP address of the update server. The special server 36 then rejects any connection requests, so that no background update is provided to the user device 50.

As an example in accordance with an embodiment of a disallowed background update, if an application seeking a Microsoft Windows® update tries to resolve the hostname windowsupdate.com by sending a DNS query to the special DNS server 34, the special DNS server 34 would see windowsupdate.com on the blacklist of sites/domains, so it would return the IP address of a/the special server 36 maintained by the MVNO rather than the actual update server maintained by Microsoft. The user device 50 would then try to connect to the special server 36, which it thinks is the update server, and the connection would be rejected by the special server 36. The application on the user device 50 seeking the background update may then either quit the background update or retry. Each retry would also be rejected by the special server 36, so the connection would never get made, and the background update would be blocked so as to reduce data usage. In some embodiments, the special server 36 may send back a reply to the user device 50 instructing the user device 50 not to retry the rejected connection, and the user device 50 may be configured such that it would not retry the connection upon receiving such an instruction. In some embodiments, there are several different special servers that each have a different rejection style, and the blacklist of sites/domains specifies which rejection style to use for each site/domain on the blacklist. In such embodiments, the special DNS server 34 would return an IP address of one of the several different special servers that carries out the rejection style specified for the site/domain requested by the user device 50.

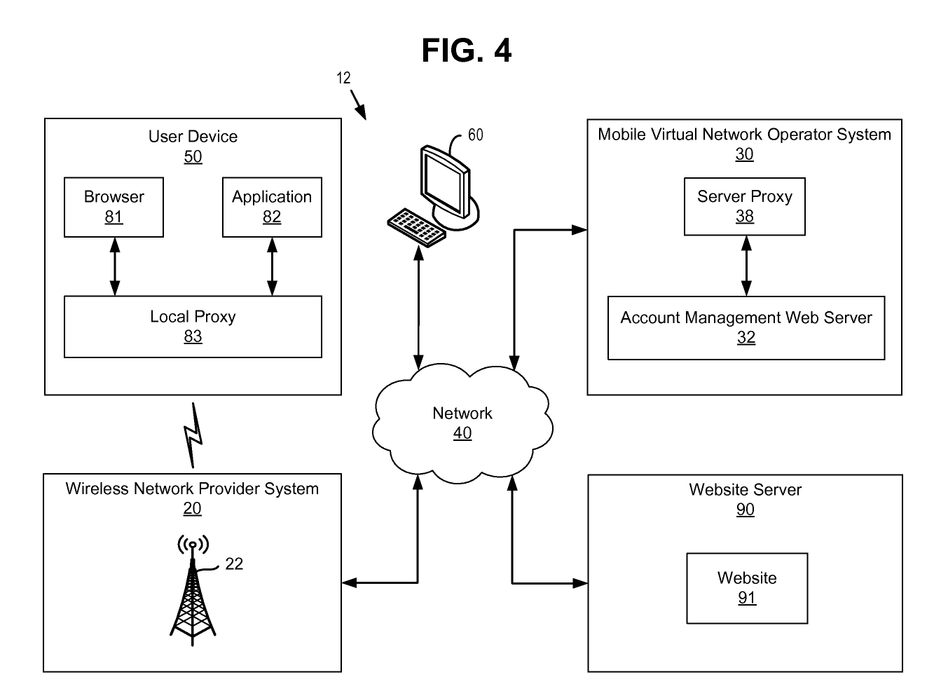

FIG. 4 is a portion 12 of the system 10 of FIG. 1 in accordance with an embodiment. With reference to FIGS. 1 and 4, the portion 12 of the system 10 includes the wireless network provider system 20, the MVNO system 30, the network 40, the user device 50, and the access device 60. The portion 12 of the system 10 further includes a website server 90 that serves a website 91. In various embodiments, a web browser 81 and one or more other application(s) 82 are installed on the user device 50. Also, in various embodiments, a local proxy 83 is installed on the user device 50, and the browser 81 and application 82 may communicate with the local proxy 83. In various embodiments, the MVNO system 30 includes a server proxy 38, which may run on a server computer, such as the account management web server 32, the special server 36, or another server. The server proxy 38 may be configured to provide statistical information about data usage to the account management web server 32 for reporting to the user.

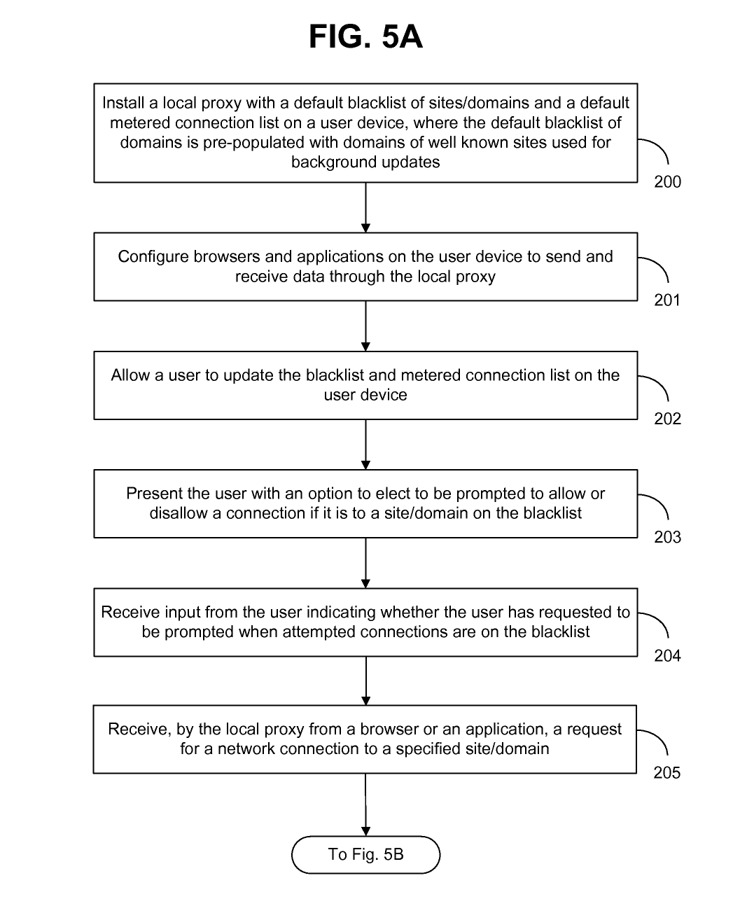

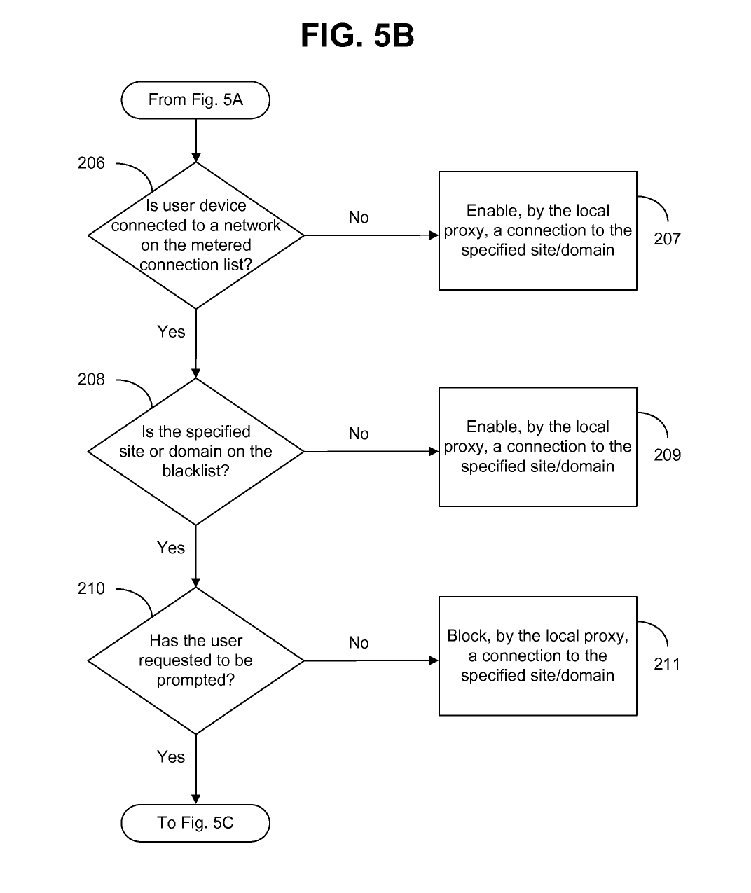

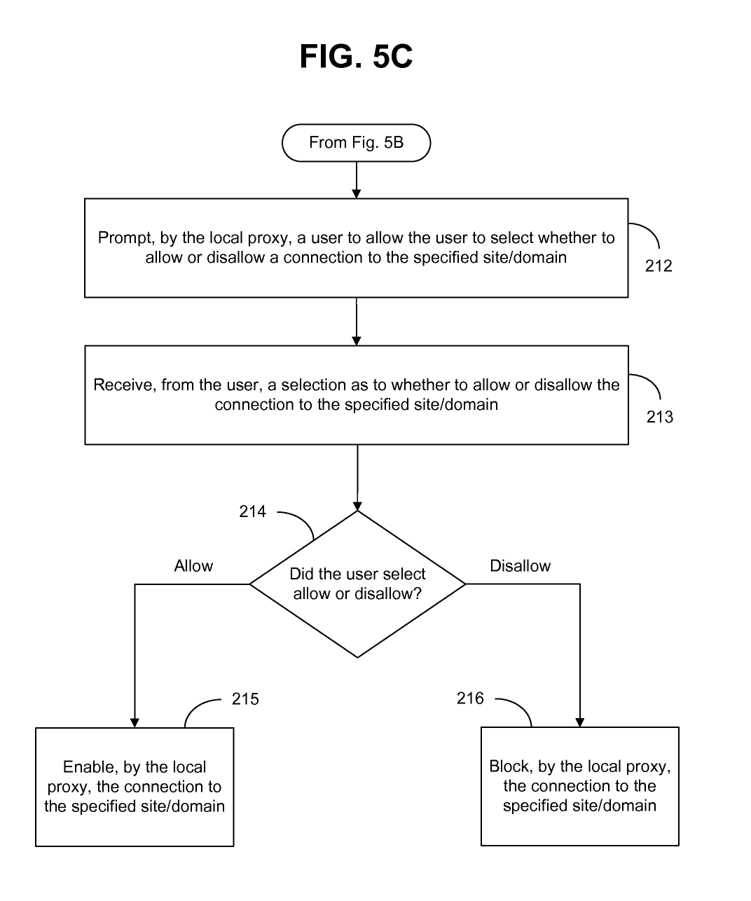

FIGS. 5A-5C show a flowchart in accordance with an embodiment that uses a local proxy on a user device to enable or block connections to specified domains. With reference to FIGS. 1, 4, and 5A-5C, in step 200 the local proxy 83 is installed on the user device 50. The local proxy 83 is installed with a default blacklist of sites/domains and also with a default metered connection list of network types and names for networks that use metered connections. In various embodiments, the default blacklist of domains is pre-populated with domains of well known sites used for background updates. In various embodiments, the default metered connection list is pre-populated with network types of networks that require metered connections for which background downloads should be disallowed when the user device 50 is connected to networks of such network types, and also includes names of networks for which background downloads should be disallowed when the user device 50 is connected to any of those named networks. In various embodiments, the server proxy 38 provides for real-time updates to the blacklist on the local proxy 83. Also, in various embodiments, the user can add or delete entries in the blacklist or the metered connection list. In various embodiments, the metered connection list maintained by the local proxy 83 specifies which connections for the user device 50 are metered. In some embodiments, the local proxy 83 uses a heuristic to guess the connections that are metered to be added to the metered connection list, and the local proxy 83 allows the user to correct or override the entries on the metered connection list. The method then continues to step 201.

In step 201, the browser 81 and any other application(s) 82 on the user device 50 are configured to send and receive data through the local proxy 83. The method then continues to step 202. In step 202, a user is allowed to update the blacklist and metered connection list on the user device 50. For example, the user could add domain names to the blacklist for sites that the user knows are used for background updates for applications, or remove names from the blacklist for sites the user wants to allow to provide background updates. As another example, the user could add network types or names to the metered connection list to disallow background updates when the user device 50 is connected to the named networks or networks of the specified types. The user could also remove network types or names from the metered connection list. In various embodiments, the local proxy 83 is configured to use the blacklist of sites/domains to control connections to sites on the blacklist when the user device 50 is connected via a connection that is on the metered connection list. In some embodiments, the local proxy 83 also stores a MIME blacklist, which specifies file types for which requests are to be disallowed for the user device 50 when the user device 50 is connected via a connection that is on the metered connection list. In some embodiments, the local proxy 83 is configured to discover whether or not a connection is metered and should be added to the metered connection list. For example, for an 802.11 Wi-Fi connection for the user device 50, it is possible that when connected via such a network type that the connection is unmetered (e.g. public Wi-Fi, work Wi-Fi, home Wi-Fi basestation on a DSL or cable network, etc.) or the connection could be metered (e.g. connected to a MiFi device that speaks 802.11 and 3G/4G for uplink, etc.). In such examples, in various embodiments the local proxy 83 is configured to provide a discovery mechanism by making a network connection to a special server within the MVNO system 30, which would then look at the connecting IP address and determine or make a guess about whether the connection is transiting a metered network of some kind. The method then continues to step 203.

In step 203, the user is presented with an option to elect to be prompted to allow or disallow a connection if it is to a site/domain on the blacklist. In various embodiments, the user is presented with the option by the user device 50 and can make a selection on the user device 50. In some embodiments, the user is presented with the option in the access device 60 and can make a selection on the access device 60, where the selected option is then applied for the user device 50. The method then continues to step 204. In step 204, input is received from the user indicating whether the user has requested to be prompted when attempted connections are on the blacklist. The indication as to whether or not the user wants to be re-prompted can be stored by the local proxy 83 in the user device 50. The method then continues to step 205.

In step 205, the local proxy 83 receives from the browser 81 or from one of the other application(s) 82, a request for a network connection to a specified site/domain. The request may be generated for requesting a background update from the specified domain or may just be a request for downloading data for another reason. The method then continues to step 206. In step 206, the local proxy 83 determines whether or not the user device 50 is connected to a network or via a connection that is on the metered connection list or that is of a type that is on the metered connection list. If it is determined in step 206 that the user device 50 is not connected to a network that is on the metered connection list and is not connected to a network that is of a type that is on the metered connection list, then the method continues to step 207. In step 207, the local proxy 83 enables a connection to the specified site/domain, so that the communication can occur with the specified site/domain, which may include a background update for the browser 81 or application(s) 82.

On the other hand, if it is determined in step 206 that the user device 50 is connected to a network that is on the metered connection list or that is of a type that is on the metered connection list, then the method continues to step 208. In step 208, the local proxy 83 determines whether the specified site or domain is on the blacklist. If it is determined in step 208 that the specified site or domain is not on the blacklist, then the method continues to step 209. In step 209, the local proxy 83 enables a connection to the specified site/domain, so that the communication can occur with the specified site/domain, which may include a background update for the browser 81 or application(s) 82. In some embodiments, the local proxy 83 performs connection management and interacts with the user. Also, in some embodiments, all connections are proxied to the server proxy 38, which then makes the connection to the desired origin server (possibly going through an additional layer of caching on the way). In various embodiments where the local proxy 83 is used for enabling connections, the server proxy 38 could be replaced with an application server to get and/or set settings and updates at the expense of no longer being able to do compression on traffic being sent or received. If it is determined in step 208 that the specified site/domain is on the blacklist, then the method continues to step 210.

In step 210, the local proxy 83 determines whether the user has requested to be prompted with an option to allow or disallow the connections to the specified domain that is on the blacklist. If it is determined in step 210 that the user has not requested to be prompted, then the method continues to step 211. In step 211, the local proxy 83 blocks a connection to the specified site/domain, so as to prevent any background download for a background update. On the other hand, if it is determined in step 210 that the user has requested to be prompted, then the method continues to step 212. In step 212, the local proxy 83 prompts the user to allow the user to select whether to allow or disallow a connection to the specified site/domain, and the method continues to step 213. In step 213, the local proxy 83 receives from the user a selection as to whether to allow or disallow the connection to the specified site/domain, and the method continues to step 214. In step 214, the local proxy 83 determines whether the user selected to allow or disallow the connection to the specified site/domain.

If it is determined in step 214 that the user has selected to allow the connection to the specified site/domain, then the method continues to step 215. In step 215, the local proxy 83 enables the connection to the specified site/domain. On the other hand, if it is determined in step 214 that the user has selected to disallow the connection to the specified site/domain, then the method continues to step 216. In step 216, the local proxy 83 blocks the connection to the specified site/domain, so as to prevent any background download for a background update. By blocking the connection and preventing any background update, an amount of data usage can be reduced, which allows for reducing an amount owed for a metered data plan. Various styles and methods of rejection may be supported in various different embodiments, because it may be desired to support different styles and methods of rejection. For example, in various embodiments, the local proxy 83 could support a method of active rejection or a method of passive rejection.

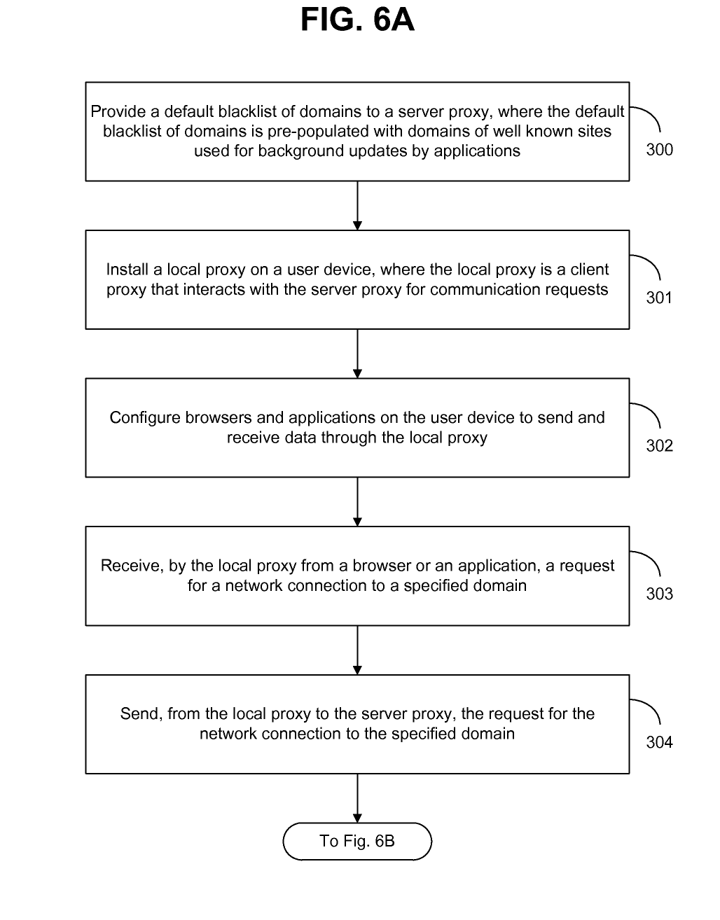

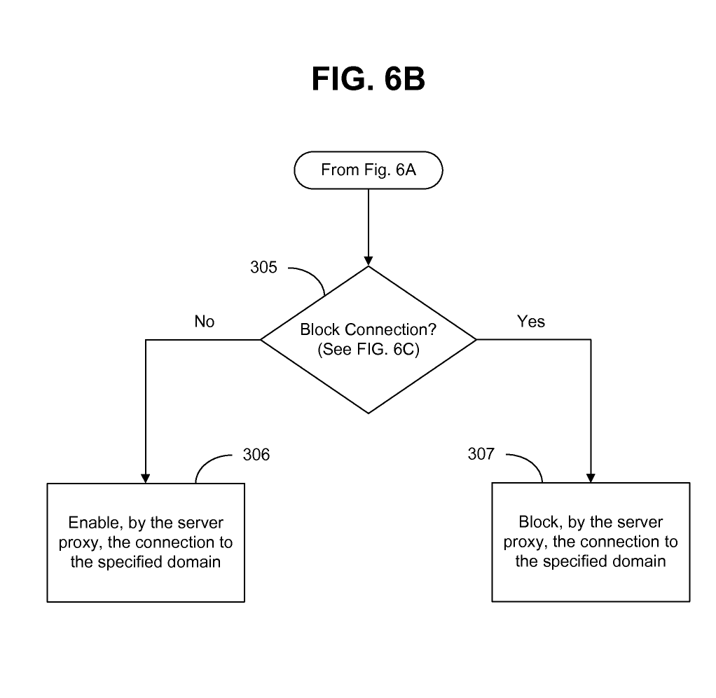

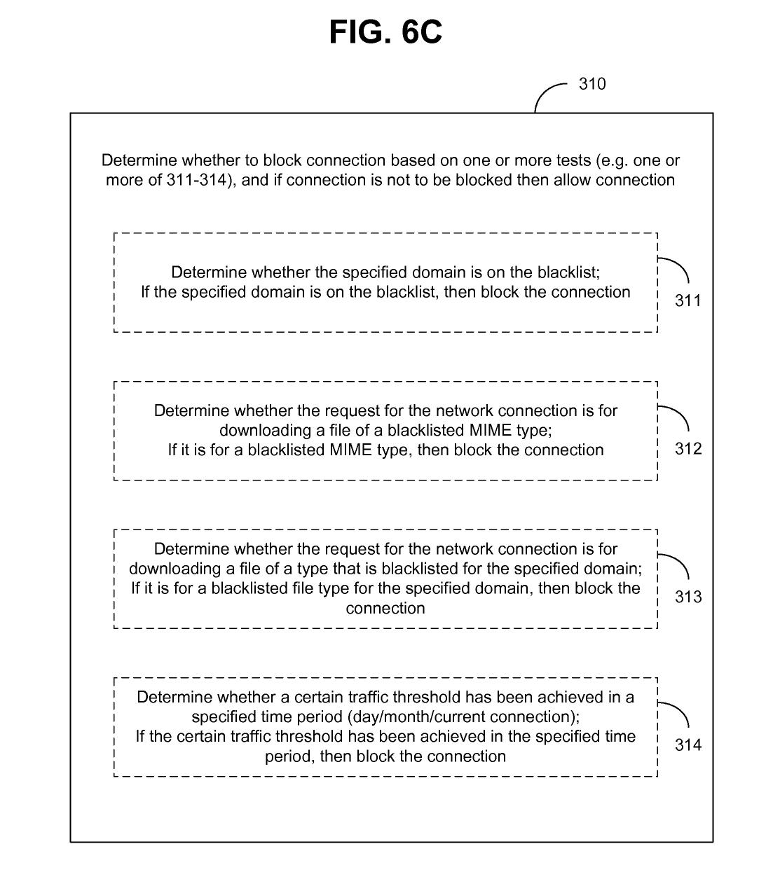

FIGS. 6A-6C show a flowchart in accordance with an embodiment that uses a local proxy on a user device and a server proxy to enable or block connections to specified domains. With reference to FIGS. 1, 4, 6A, 6B, and 6C, in step 300 a default blacklist of domains is provided to the server proxy 38, where the default blacklist of domains is pre-populated with domains of well known sites used for background updates by applications. The method then continues to step 301. In step 301, the local proxy 83 is installed on the user device 50, where the local proxy 83 is a client proxy that interacts with the server proxy 38 for communication requests. The method then continues to step 302. In step 302, the browser 81 and other application(s) 82 on the user device 50 are configured to send and receive data through the local proxy 83, and the method continues to step 303. In step 303, the local proxy 83 receives from the browser 81 or one of the other application(s) 82, a request for a network connection to a specified domain, and the method continues to step 304. In step 304, the local proxy 83 sends to the server proxy 38 the request for the network connection to the specified domain, and the method continues to step 305.

In step 305, the server proxy 38 determines whether to block the network connection using the method shown in step 310. Step 310 provides a method in accordance with an embodiment for determining whether to block a network connection based on one or more tests (e.g. one or more of the determining steps shown in steps 311, 312, 313, and 314), and if the network connection is not to be blocked, then the connection is allowed. In various embodiments, the server proxy 38 has access to information about the request and can block the request for one or more reasons. For example, the step 311 determines whether the specified domain is on the blacklist and, if it is, then the network connection is to be blocked. The step 312 determines whether the request for the network connection is for downloading a file of a blacklisted MIME type and, if it is, then the network connection is to be blocked. The step 313 determines whether the request for the network connection is for downloading a file of a type that is blacklisted for the specified domain and, if it is, then the network connection is to be blocked. The step 314 determines whether a certain traffic threshold has been achieved in a specified time period (day/month/current connection) and, if it has, then the network connection is to be blocked. One or more of the steps 311-314 can be used for step 310 to make a determination as to whether to block the requested network connection, and the determination from step 310 is used for the decision step 305. If it is determined in step 305 that the connection is not to be blocked, then the method continues to step 306. In step 306, the server proxy 38 enables the connection to the specified domain, so that any background update can proceed. On the other hand, if it is determined in step 305 that the connection is to be blocked, then the method continues to step 307. In step 307, the server proxy 38 blocks the connection to the specified domain, so that any background update is prevented. By blocking the connection and preventing any background update, an amount of data usage can be reduced, which allows for reducing an amount owed for a metered data plan.

In accordance with various embodiments, the use of a client/agent, such as the local proxy 83, installed on the user device 50 allows for fine grained control of background downloads by (i) permitting background downloads based on domain; (ii) prompting at each occurrence of an attempted background download for confirmation (and in some embodiments showing previous usage with the site to which a connection is requested to provide the user with a guess as to how much data might be used if the connection is accepted); and/or (iii) enabling all connections and background downloads for whitelisted network types and/or names (e.g., allow background downloads when the user device 50 has a wired network connection or is connected to specific 802.11 networks).

In various embodiments, a mobile virtual network operator codes an end point client, such as the local proxy 83, and places the local proxy 83 on end user devices, such as the user device 50, to proxy connections through the client side local proxy. Also, in various embodiments, local web browsers, such as the browser 81, and other applications, such as the application 82, on an end user device, such as the user device 50, are configured to send all or a portion of data traffic through a local proxy, such as the local proxy 83, on the end user device. In various embodiments, a client proxy, such as the local proxy 83, permits or denies connections based on a domain to which a connection is requested to be made. Also, in various embodiments, a client side proxy, such as the local proxy 83, checks if a user wants to allow a connection to a specific domain for each background download by prompting at each occurrence of a background download request for user confirmation as to whether the user wants to allow the background update (e.g., with a yes/no option to be selected by the user). In some embodiments, when the local proxy 83 prompts the user for user confirmation as to whether the user wants to allow the background update, the prompt can further provide possible answers for the user to select that are flexible about when or if the user should be reprompted for future connection requests, such as (a) never reprompt for this site/domain; (b) reprompt at the next attempted connection to this site/domain; and/or (c) reprompt for every attempted connection to this site/domain.

In various embodiments, there is a default blacklist of sites that is sent from the MVNO system 30 to local proxies, such as the local proxy 83 on the user device 50. The default blacklist is pre-populated with well known sites used for background updates of applications. In some embodiments, the user device 50 can be used by a user to add and/or delete sites from the blacklist or configure the blacklist with commands to prompt for sites (e.g., user specifies that for three particular sites the user should be prompted when connections are attempted and that for two other specific sites the connections to those sites should always be blocked).

In various embodiments, a whitelist is used to specify that background updates should be allowed when a user device is connected to a network of a specified type or having a specified name. For example, some user devices, such as some smart phones, are able to connect to both Wi-Fi and cellular networks. Also, different Wi-Fi networks can have different names. A whitelist could be used to specify, for example, that background downloads for background updates should not be allowed for Wi-Fi networks with specific names or for cellular connections, but should be allowed when the user device is connected to any other Wi-Fi network. Various embodiments also allow for auto-discovery in which an informed guess is made about whether a connection is metered and then the guess is confirmed or changed by the user the first time the connection and/or Wi-Fi network is used. For example, for an 802.11 Wi-Fi connection, it is possible that when connected via such a network type that the connection is unmetered (e.g. public Wi-Fi, work Wi-Fi, home Wi-Fi basestation on a DSL or cable network, etc.) or the connection could be metered (e.g. connected to a MiFi device that speaks 802.11 and 3G/4G for uplink, etc.). In such examples, in various embodiments a discovery mechanism allows for making a network connection to a special server within an MVNO system, which would then look at the connecting IP address and determine or make a guess about whether the connection is transiting a metered network of some kind.

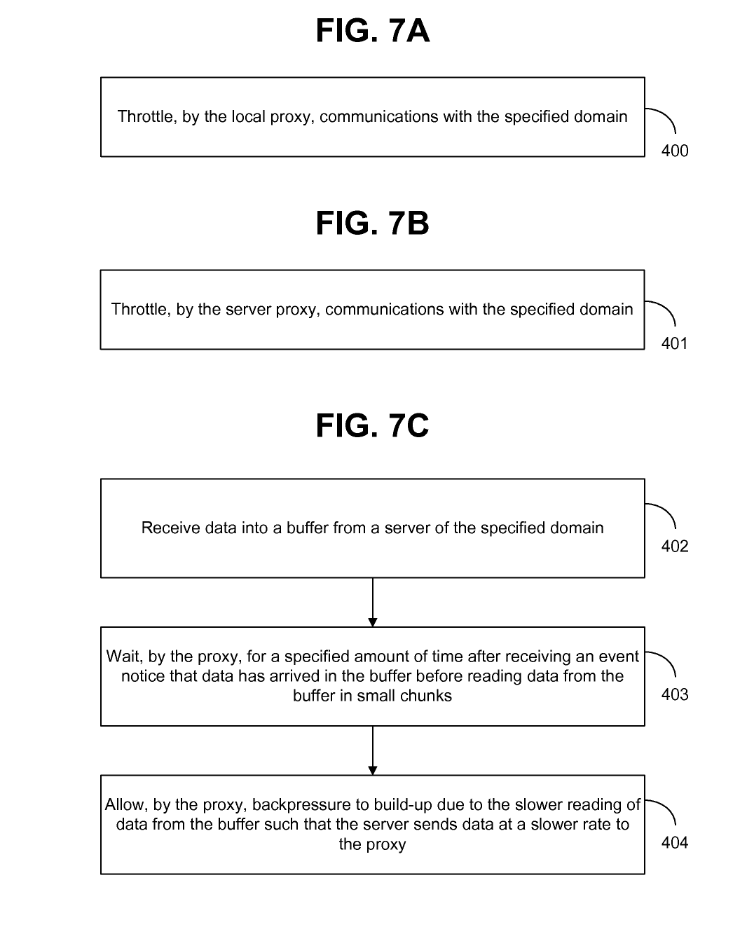

FIG. 7A is a method of throttling communications by a local proxy that can be used rather than blocking communications in various embodiments. With reference to FIGS. 4 and 7A, in step 400 the local proxy 83 throttles communications with a specified domain, which limits a rate at which data is downloaded from the specified domain. With reference to FIGS. 4, 5A-5C, and 7A, in various embodiments the step 400 is used in place of the step 211 and in place of the step 216, such that rather than the local proxy 83 blocking a connection it would throttle the connection to limit a data rate for the connection. In such embodiments, the step 203 would present a user with an option to elect to be prompted to allow or throttle a connection if it is to a domain on the blacklist, rather than having an option to allow or disallow. In some embodiments, the user could be given an option to elect to be prompted to allow or throttle or disallow a connection if it is to a domain on the blacklist or if the request is for a certain MIME type (e.g. streaming video), such that the user could select from those three choices. In the case where the user is prompted to throttle a connection, the step 212 would ask the user to select whether to allow or throttle, and the step 213 would receive the selection of whether the user wants to allow or throttle, and the decision in step 214 would then check if the user wants to allow or throttle. If it is determined that the user wants to throttle the connection, then it would be throttled according to step 400.

FIG. 7B is a method of throttling communications by a server proxy that can be used rather than blocking communications in various embodiments. While FIG. 7B provides a method for throttling by a server proxy, various other embodiments may perform throttling without using a server proxy, such as by having a local proxy that is configured to do the throttling. With reference to FIGS. 4 and 7B, in step 401 the server proxy 38 throttles communications with a specified domain, which limits a rate at which data is downloaded from the specified domain to be provided from the server proxy 38 to the local proxy 83. With reference to FIGS. 4, 6B, and 7B, in various embodiments the step 401 is used in place of the step 307, such that rather than the server proxy 38 blocking a connection it would throttle the connection to limit a data rate for the connection. Thus, various embodiments allow for the throttling of a connection for a background update instead of blocking the connection. Throttling the connection artificially reduces how much data is transmitted and allows the download to occur but to happen at a slower rate. For example, a download could be throttled to occur at 1/10 of normal speed. The throttling of the connection can also affect the way data is sent from servers. For example, for certain types of downloads (e.g. certain types of streaming video), the streaming video server senses the available bandwidth and adjusts its compression such that the viewed display frame rate is maintained. In such examples, when the connection is throttled, the streaming video server can automatically adjust the compression for the video being transmitted. In various embodiments, the downloaded data is transmitted from the server proxy 38 of the MVNO system 30 to the local proxy 83 on the user device 50, so the server proxy 38 is able to throttle the data transmission. In various other embodiments, the throttling is performed by the local proxy 83 itself without the need for the server proxy 38 to do the throttling.

Some embodiments allow for inactivity based throttling and/or choking-off of network connections (e.g., if no interaction with user device and after some period of time then connections for the user device are throttled). Such inactivity based timing may be controlled by the local proxy 83, which could then throttle and/or choke-off a network connection when there is inactivity of a user with respect to using the user device 50. In various embodiments, the inactivity function blocks all connections that are metered connections and not just those on the various blacklists.

FIG. 7C is a flowchart of a method in accordance with an embodiment for throttling communications by a proxy. With reference to FIGS. 1, 4 and 7C, in step 402 data is received into a buffer from a server, such as the update server 72, the update server 74, or the website server 90, of a specified domain. In some embodiments, the buffer is maintained by the local proxy 83. Also, in some embodiments, the buffer is maintained by the server proxy 38. The method then continues to step 403. In step 403, the proxy maintaining the buffer, such as the local proxy 83 or the server proxy 38, waits for a specified amount of time after receiving an event notice that data has arrived in the buffer before reading data from the buffer in small chunks. The method then continues to step 404. In step 404, the proxy maintaining the buffer, such as the local proxy 83 or the server proxy 38, allows backpressure to build-up due to the slower reading of data from the buffer such that the server that is sending data sends the data at a slower rate to the proxy. Thus, by slowing the rate at which data is read from the buffer, the proxy is able to throttle the connection to reduce the rate at which the server sends the data to the rate that the data is being read from the buffer on the local client.

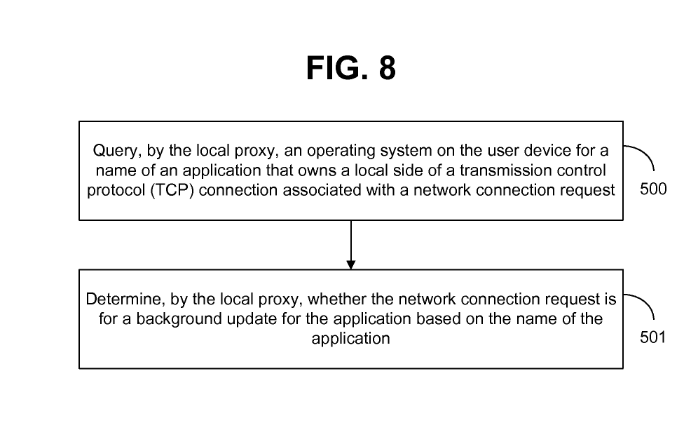

FIG. 8 is a flowchart of a method in accordance with an embodiment for determining whether a network connection request is for a background update for an application. In various embodiments, the method of FIG. 8 is used to supplement a blacklist, such that after a blacklist is consulted and a domain is not found on the blacklist, a check is further performed using the method of FIG. 8 to determine whether a connection to the domain should nevertheless still be prevented. With reference to FIGS. 4 and 8, in step 500 the local proxy 83 queries an operating system on the user device 50 for a name of an application that owns a local side of a transmission control protocol (TCP) connection associated with a network connection request. The method then continues to step 501. In step 501, the local proxy 83 determines whether the network connection request is for a background update for the application based on the name of the application that owns the local side of the TCP connection. With reference to FIGS. 6B, 6C, and 8, the method of FIG. 8 could be performed, for example, and the result used for another option for a determining step in step 310 that is used to make the decision in step 305. In such an example, if the result of the method of FIG. 8 is that the network connection request is for a background update, then the connection could be blocked using step 307 of FIG. 6B rather than enabling the connection as would otherwise occur in step 306. In various embodiments, the presence of the local proxy 83 provides other attributes of the request to use in the block/throttle decision making process.

Thus, in various embodiments there are different ways to determine whether an attempted connection is for a background update. In some embodiments, well known background update sites such as Microsoft Windows® update for Internet Explorer® updates and Symantec® update for Norton Anti-Virus® updates are placed on the blacklist, which is consulted to determine whether to allow or disallow connections. For sites that are not on the blacklist, a further check can be made to determine whether connection requests for such sites are for background updates using the method of FIG. 8. In such embodiments, an operating system is queried for a name of an application that owns a local side of a TCP connection to a proxy, such as the local proxy 83 of FIG. 4, for a connection request. For example, the local proxy 83 may receive a TCP request and then ask the operating system of the user device 50 what application is connected to local port associated with the TCP request. In various embodiments, if the operating system replies with a name of an application that is known to receive background updates, then the local proxy 83 blocks or throttles the connection. In some embodiments, the connection may be blocked or throttled based on one or more other attributes of the request for the attempted connection in addition to or instead of the site/domain in the request.

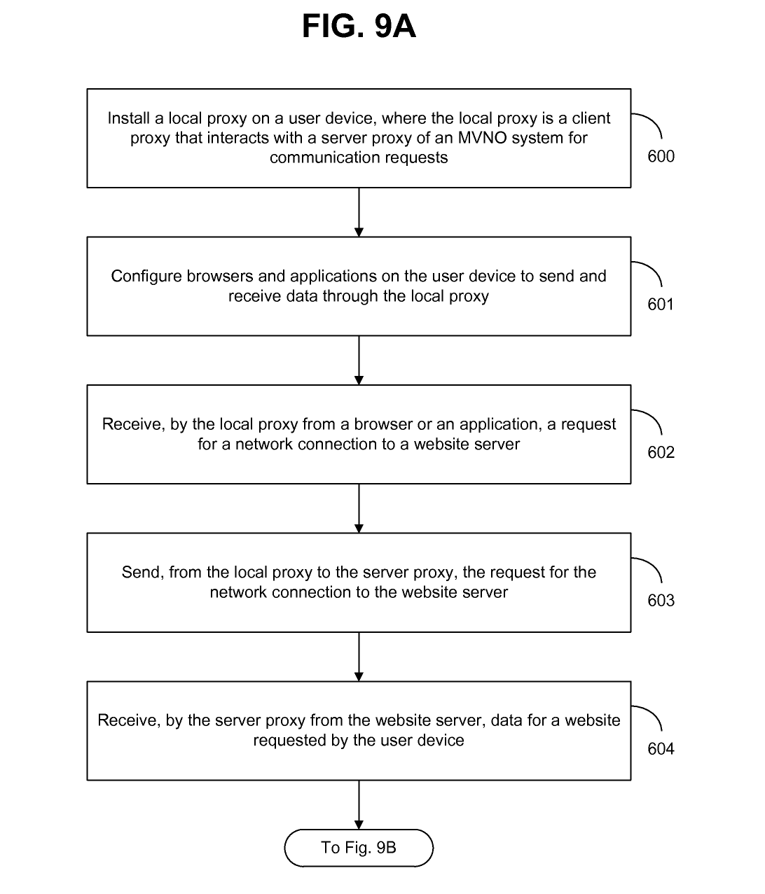

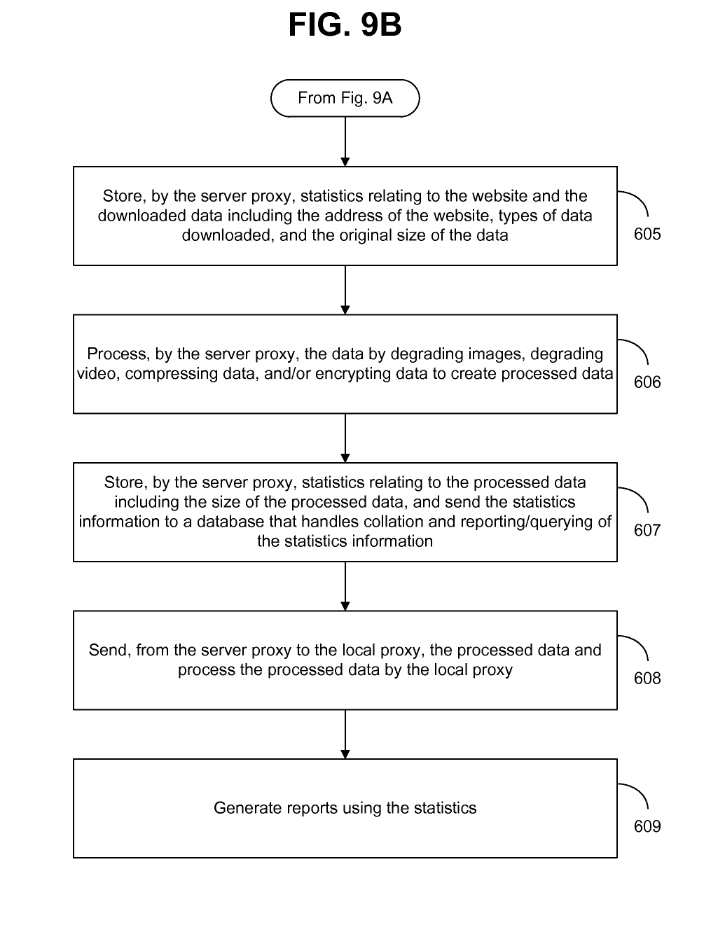

FIGS. 9A and 9B show a flowchart of a method for degrading, compressing, and/or encrypting data by a server proxy to be provided to a local proxy and for reporting statistics related to the data to a user. With reference to FIGS. 4, 9A, and 9B, in step 600 the local proxy 83 is installed on the user device 50, where the local proxy 83 is a client proxy that interacts with the server proxy 38 of the MVNO system 30 for communication requests. The method then continues to step 601. In step 601, browsers and applications on the user device 50, such as the browser 81 and the application 82, are configured to send and receive data through the local proxy 83. The method then continues to step 602. In step 602, the local proxy 83 receives from a browser or other application a request for a network connection to a website server, such as the website server 90, to download content from a website, such as the website 91. The method then continues to step 603.

In step 603, the local proxy 83 sends to the server proxy 38 a request for a network connection to the website server, such as the website server 90, and the method continues to step 604. In step 604, the server proxy 38 receives from the website server, such as the website server 90, data for a website, such as the website 91, requested by the user. The method then continues to step 605. In step 605, the server proxy 38 stores statistics relating to the website and the downloaded data including, for example, the address of the website, the types of data downloaded (e.g., text, images, video, and the like), and the original size of the data (e.g., the file size of each object downloaded). In some other embodiments, the statistics are stored by the local proxy 83 and the server proxy 38 is not a necessary element for the statistics gathering. The method then continues to step 606.

In step 606, the server proxy 38 processes the received data by degrading images, degrading video, compressing data, and/or encrypting the data to create processed data. For example, if the data from the website includes images and videos, the images and videos can be degraded in quality or detoned to lower a data size of the images and videos, so that less data needs to be transmitted back to the user device 50 to conserve data usage. The images and video can be degraded, for example, by reducing a number of bits used to code color information, reducing a number of pixels to reduce a resolution, and/or the like. Also, for example, if the data includes text then the text could be compressed to lower a data size so that less data needs to be transmitted back to the user device 50. Also, the data can be encrypted before transmission back to the user device 50 to provide security for the data traffic. Such encryption could be beneficial if, for example, the user device 50 is on a public Wi-Fi network or roams onto a shared Wi-Fi network and wants to hide traffic from attackers. The method then continues to step 607.

In step 607, the server proxy 38 stores statistics relating to the processed data including the size of the processed data (e.g., the resulting size of each of the degraded, compressed, and/or encrypted files), and the server proxy 38 sends the statistics information to a database or data warehouse that will handle collation and reporting/querying of the statistics information. In various embodiments, the server proxy 38 acts as a staging mechanism to send the statistics information on to the database and/or data warehouse. The method then continues to step 608. In step 608, the server proxy 38 sends the processed data to the local proxy 83, and the local proxy 83 processes the processed data to for display on the user device 50. For example, the local proxy 83 decrypts any encrypted data and decompresses any compressed data. The method then continues to step 609. In step 609, reports are generated using the statistics. In various embodiments, the reports are transmitted to the user. In some embodiments, reports are generated on demand in cases where the user is specifically trying to peruse the statistics information. In various embodiments, periodic updates of very high level summary statistics are maintained locally by the local proxy 83 for decision making and heuristic purposes, while more detailed statistical data is maintained by the network provider or MVNO.

In various embodiments, the account management web server 32 transmits the reports to the access device 60 and/or the user device 50 for review by the user. In some embodiments, the reports transmitted for viewing by the user include per-site data usage statistics (which may also be reported per user device), and which are accessible and visible on a customer account site for the user (which can segregate information out for reporting per user device). In various embodiments, the reports include per-mime-type data usage statistics (e.g., statistics for text, mail, images, and video) for review on the account management site with their original and transferred sizes. In various embodiments, the transferred size is the size of the data after processing by the server proxy 38 as it is transferred from the server proxy 38 to the local proxy 83. In various embodiments, the reports specify and allow a user to see at a glance (and to see more detail in an account site) how much data has been used and reduced from an original size through compression and/or degradation. In various embodiments, that kind of high level summary information is maintained on the client side, such as at the user device.

In various embodiments, the reports specify information about how much data has been downloaded and a date for each download. Also in various embodiments, the reports are generated to specify a percentage of data that is of each mime type (e.g., text, mail, image, video) and a percentage of data that was downloaded for each visited website. The reports can also be generated, for example, by the account management web server 32 to specify how much network usage has actually been used, how much data has been downloaded per month, and how much data can be downloaded before there are additional charges under a data plan for the user. The reports allow for educating users as to how much data they are using and the amount of data transmitted for each site. For example, a user may notice from the reports that the ESPN® website is data intensive and then avoid accessing the ESPN® website when on a wireless network. The reports can also be generated to specify statistics for text, images, and video so the user can see how much data of each type has been downloaded.

In various embodiments, the reports are generated to allow the user to see at a glance how much data has been used and then the user can input a command to the user device 50 to be sent to the server proxy 38 to reduce any further downloaded data through compression and/or degradation. In various embodiments, reports are generated that include suggestions to the user about how to reduce data usage, such as asking if the user wants to throttle downloading of various types of data, such as an option for the user to select to cause the server proxy 38 and/or local proxy 83 to throttle the downloading of video data. In various embodiments, the account management web server 32 maintains statistics of data usage by user and then alerts the user if they are exceeding their average data usage (e.g., alerting a user that they are watching more than an average amount of video than they usually watch). Alerting the user about the type and/or amount of data usage is advantageous for the user because without such an alert a user may be unaware of the kinds of data they are using and over a period of successive days may forget how much data they have already used for the month. When given an alert, a user can adjust data usage and, in a case where the network is metered such as for various types of wireless broadband networks, the user can potentially save money from adjusting the data usage. In various embodiments a client or agent program, such as the local proxy 83 on the user device 50 compresses and/or encrypts transmissions to the server proxy 38. Thus, in various embodiments both an uplink and a downlink are compressed and/or encrypted from a local proxy to a server proxy. In some embodiments, if images and/or video are degraded by the server proxy 38, an option may be provided to the user to download the original version of the images and/or video. In some embodiments, reports are generated to inform the user how much data the user could save with other settings, such as enabling degradation of images and video and allowing for compression. Also, in some embodiments, reports are generated that show the user how much data usage the user did save with current settings due to compression and/or degradation.

In various embodiments, the account management web server 32 generates overall statistics among a plurality of users as part of a marketing service for marketing purposes. The overall statistics may include information about user devices and downloaded data, such as browser type used, protocol used for downloading, websites accessed, content type of downloaded data, device type of the user device, and/or speed of communication of the download. In some embodiments, the users can be separated into various types such as a casual user, a video user, or the like, based on the statistics and then marketing can be targeted to the users based on their type. Also, the statistics can be anonymized and sold to marketers. In various embodiments, the statistics are used to compile very detailed and drilled down information such as the type of people who look at videos, the number of videos viewed per session, per day, and/or per month, and the top websites for video downloads.

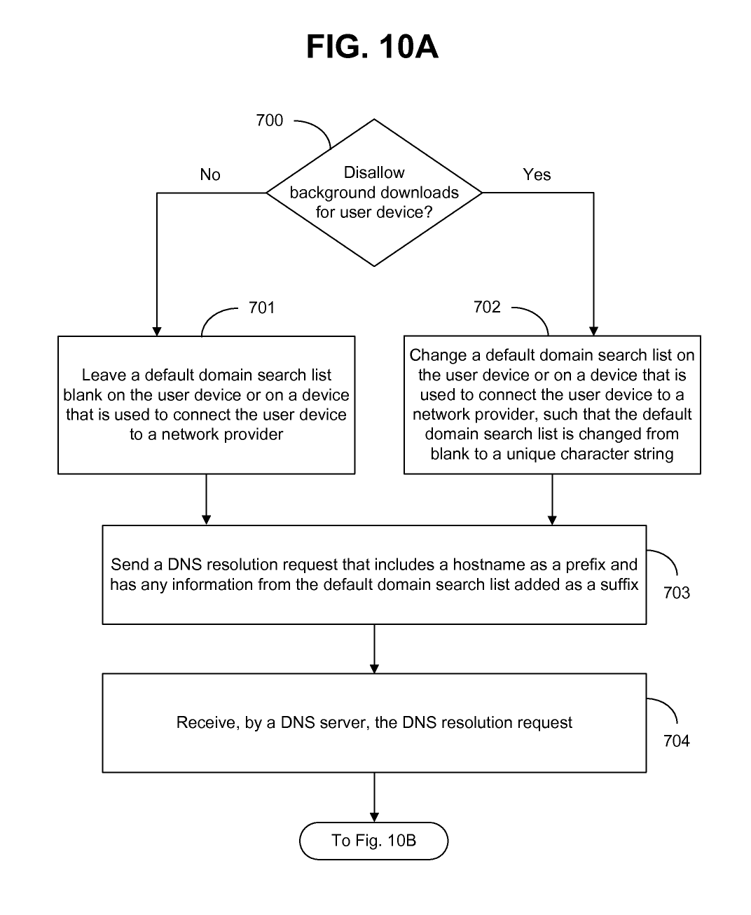

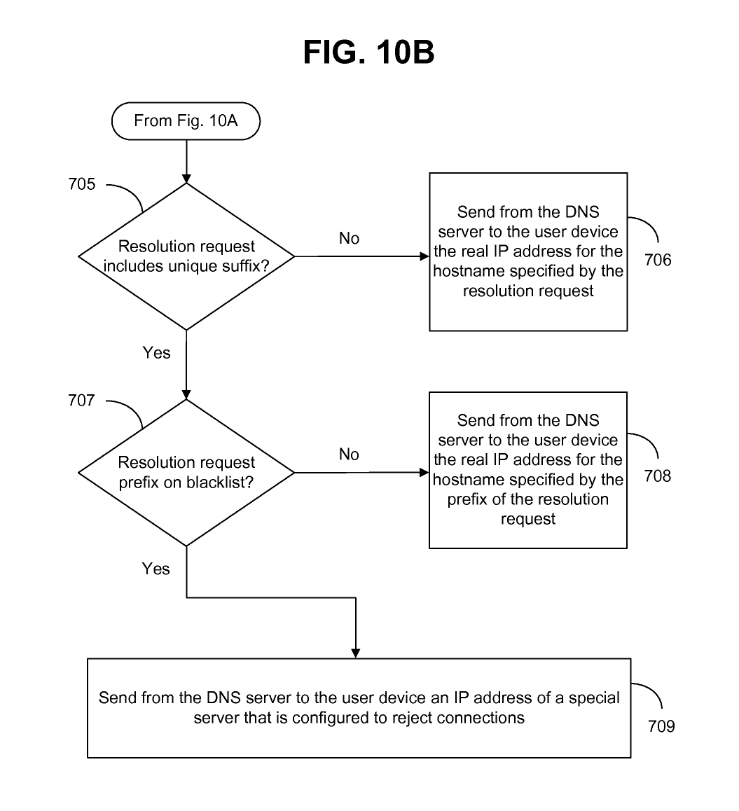

FIGS. 10A and 10B illustrate another method in accordance with an embodiment for selectively disallowing background downloads by user devices. With reference to FIGS. 1, 10A, and 10B, in step 700 it is determined whether background downloads are disallowed for the user device 50. The user of the user device 50 could have specified to either allow or disallow background downloads by applications running on the user device 50 by logging into the account management web server 32 from the user device 50 and/or the access device 60 and making a selection to either allow or disallow the background downloads. If it is determined in step 700 that the background downloads are not disallowed, which means that they are allowed, then the method continues to step 701. In step 701 a default domain search list is left blank on the user device 50 or on a device that is used to connect the user device 50 to the wireless network provider system 20, and the method continues to step 703. On the other hand, if it is determined in step 700 that background downloads are disallowed for the user device 50, then the method continues to step 702. In step 702, a default domain search list is changed on the user device 50 or on a device that is used to connected the user device 50 to the wireless network provider system 20, such that the default domain search list is changed from blank to a unique character string. For example, the default domain search list could be changed from blank to something unique and not real, such as “.nobackground.acme.com”. The method then continues to step 703.

In step 703, a DNS resolution request or query is sent from the user device 50 or a device that is used to connected the user device 50 to the wireless network provider system 20, where the DNS resolution request includes a hostname as a prefix and has any information from the default domain search list added as a suffix. If the default domain search list is blank, then no suffix is added. If the default domain search list has the unique character string, then the unique character string is added as a suffix to the hostname prefix. The method then continues to step 704. In step 704, the DNS server 33 receives the DNS resolution request. In various embodiments, the DNS server 33 is customized to handle DNS resolution requests or queries that have appended suffixes. The method then continues to step 705.

In step 705, the DNS server 33 determines whether or not the received resolution request includes the unique suffix. If it is determined in step 705 that the resolution request does not include the unique suffix, then the method continues to step 706. In step 706 the DNS server 33 sends to the user device 50 the real IP address for the hostname specified by the resolution request. On the other hand, if it is determined in step 705 that the resolution request includes the unique suffix, then the method continues to step 707. In step 707 the DNS server 33 determines whether the prefix from the resolution request is on the blacklist of sites/domains. If it is determined in step 707 that the prefix is not on the blacklist, then the method continues to step 708. In step 708 the DNS server 33 sends to the user device 50 the real IP address for the hostname specified by the prefix of the resolution request. On the other hand, if it is determined in step 707 that the prefix in the resolution request is on the blacklist, then the method continues to step 709. In step 709 the DNS server 33 sends to the user device 50 an IP address of a special server, such as the special server 36, that is configured to reject connections so that the background update is prevented.

Therefore, such a method provides another mechanism for preventing background downloads that uses a custom DNS server, and the differentiation happens by changing the default domain search list on the user device 50 or on a device that the user device 50 uses to connect to the wireless network provider system 20. In such a mechanism, if the user wants to disallow background downloads, the default domain search list is changed from blank to something unique and not real like “.nobackground.acme.com”. The DNS server 33 is modified so that if it receives a DNS resolution request or query that ends with the unique character string, such as .nobackground.acme.com, and the prefix is on the blacklist, then it returns the IP address for the special server that rejects connections. Otherwise, it returns the real IP address for the hostname specified by the prefix, which is the original fully qualified hostname.

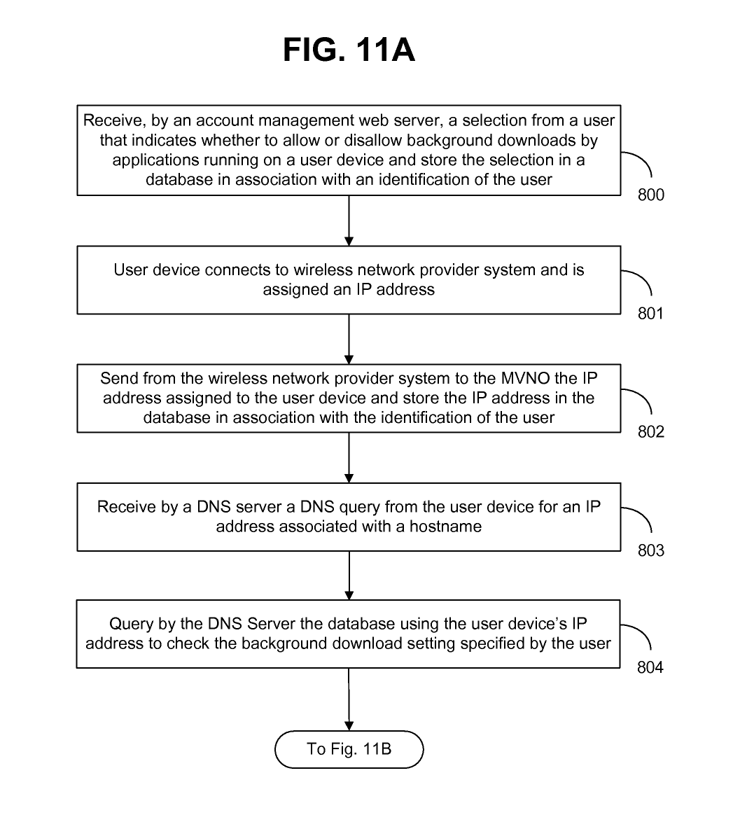

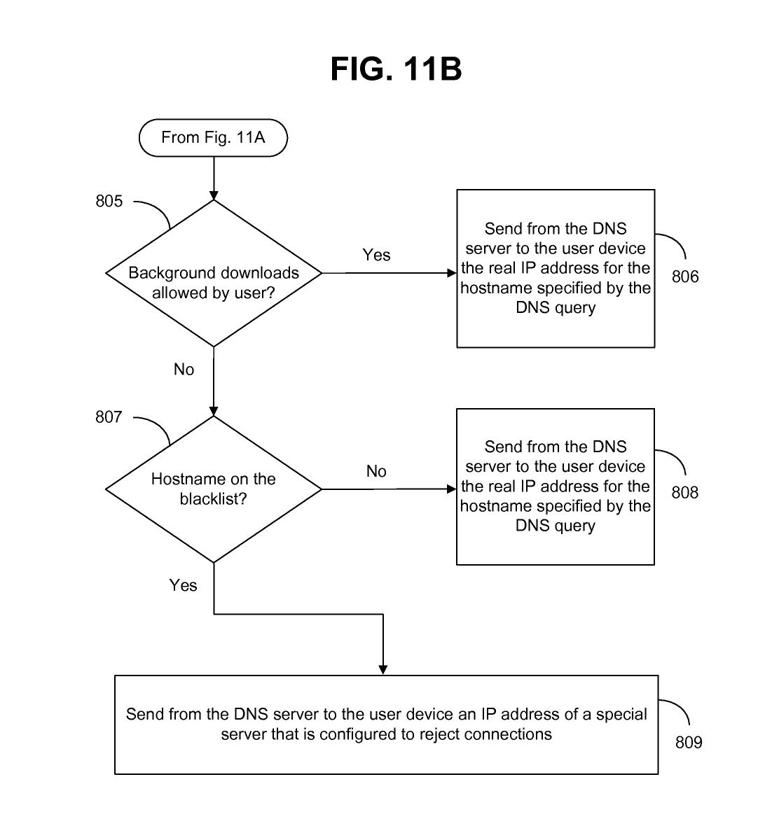

FIGS. 11A and 11B illustrate another method in accordance with an embodiment for selectively disallowing background downloads by user devices. With reference to FIGS. 1, 11A, and 11B, in step 800 the account management web server 32 receives a selection from a user that indicates whether to allow or disallow background downloads by applications running on the user device 50, and the account management web server 32 stores the selection in a database in association with an identification of the user. The database can be provided on the account management web server 32 or on any other suitable computer. The method then continues to step 801.

In step 801 the user device 50 connects to the wireless network provider system 20 and is assigned an IP address, and the method continues to step 802. In step 802 the wireless network provider system 20 sends to the MVNO system 30 the IP address assigned to the user device 50, and the MVNO system 30 stores the IP address in the database in association with the identification of the user as, for example, an IP address to user mapping in an IP address to user map. The method then continues to step 803. In step 803 the DNS server 33 receives a DNS query from the user device 50 for an IP address associated with a hostname, and the method continues to step 804. In step 804 the DNS server 33 queries the database using the IP address of the user device 50 to check the background download setting specified by the user, and the method continues to step 805.

In step 805 the DNS server 33 determines based on the background download setting whether or not background downloads are allowed by the user for the user device 50. If it is determined in step 805 that background downloads are allowed by the user, then the method continues to step 806. In step 806 the DNS server 33 sends to the user device 50 the real IP address for the hostname specified by the DNS query. On the other hand, if it is determined in step 805 that background downloads are not allowed by the user, then the method continues to step 807. In step 807 the DNS server 33 determines whether the hostname from the DNS query is on the blacklist of sites/domains. If it is determined in step 807 that the hostname is not on the blacklist, then the method continues to step 808. In step 808 the DNS server 33 sends to the user device 50 the real IP address for the hostname specified by the DNS query. On the other hand, if it is determined in step 807 that the hostname in the DNS query is on the blacklist, then the method continues to step 809. In step 809 the DNS server 33 sends to the user device 50 an IP address of a special server, such as the special server 36, that is configured to reject connections so that the background update is prevented.

Various methods in accordance with various embodiments do not require changing settings on the user device 50, but communicate an IP address and a user/device assignment that is assigned to the user device 50 from the wireless network provider system 20 to the MVNO system 30 at the time the user device 50 connects to the wireless network provider system 20. In such embodiments, the DNS server 33 in the MVNO system 30 is modified to query an IP address to User map, and then lookup the background setting for the user, and from there either return the real IP address or a special server IP address in response to a DNS query.

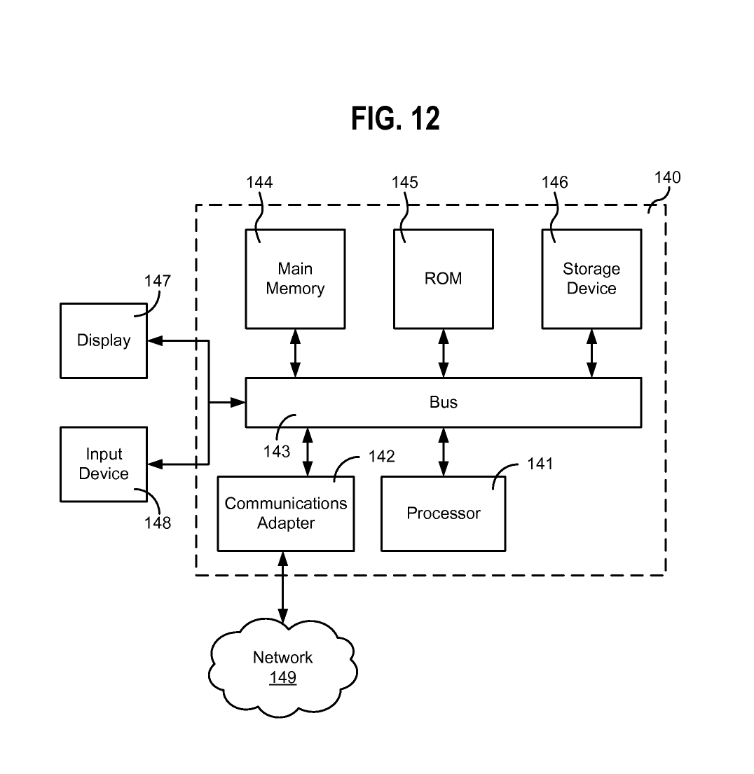

FIG. 12 illustrates a depiction of an example computing system 140. With reference to FIGS. 1, 4, and 12, the computing system 140 can be used, for example, to implement an illustrative user device 50, an illustrative access device 60, an illustrative wireless network provider server 24, an illustrative account management web server 32, an illustrative special DNS server 34, an illustrative special server 36, an illustrative update server 72, an illustrative update server 74, an illustrative website server 90, and/or various other illustrative systems that may be used in implementations as described in the present disclosure.

The computing system 140 includes a bus 143 or other communication component for communicating information, and a processor 141 coupled to the bus 143 for processing information. The computing system 140 also includes main memory 144, such as a random access memory (RAM) or other dynamic storage device, coupled to the bus 143 for storing information and instructions to be executed by the processor 141. Main memory 144 can also be used for storing position information, temporary variables, or other intermediate information during execution of instructions by the processor 141. The computing system 140 may further include a read only memory (ROM) 145 or other static storage device coupled to the bus 143 for storing static information and instructions for the processor 141. A storage device 146, such as a non-transitory, solid state device, magnetic disk or optical disk, is coupled to the bus 143 for persistently storing information and instructions.

The computing system 140 may be coupled via the bus 143 to a display 147, such as a liquid crystal display, or active matrix display, for displaying information to a user. An input device 148, such as a keyboard including alphanumeric and other keys, may be coupled to the bus 143 for communicating information and command selections to the processor 141. In another implementation, the input device 148 includes a touch screen display. The input device 148 can also include a cursor control, such as a mouse, a trackball, or cursor direction keys, for communicating direction information and command selections to the processor 141 and for controlling cursor movement on the display 147.

In some implementations, the computing system 140 may include a communications adapter 142, such as a networking adapter. Communications adapter 142 may be coupled to bus 143 and may be configured to enable communications with a computing or communications network 149 and/or other computing systems. In various illustrative implementations, any type of networking configuration may be achieved using communications adapter 142, such as wired (e.g., via Ethernet), wireless (e.g., via Wi-Fi, Bluetooth, WiMAX, etc.), pre-configured, ad-hoc, LAN, WAN, etc. In various embodiments, the communications network 149 is the network 40.

According to various implementations, various processes that effectuate illustrative implementations can be achieved using computing systems, such as the computing system 140. The processor 141 can execute an arrangement of instructions contained in main memory 144. Such instructions can be read into main memory 144 from another computer-readable medium, such as the storage device 146. Execution of the arrangement of instructions contained in main memory 144 causes the computing system 140 to perform processes. One or more processors in a multi-processing arrangement may also be employed to execute the instructions contained in main memory 144. In alternative implementations, hard-wired circuitry may be used in place of or in combination with software instructions to implement illustrative implementations. Thus, implementations are not limited to any specific combination of hardware circuitry and software.

Although an example processing system has been described in FIG. 12, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Various implementations can be carried out using digital electronic circuitry, or in computer software, firmware, or hardware, including the structures disclosed in this specification and their structural equivalents, or in combinations of one or more of them. Various implementations can be implemented as one or more computer programs, i.e., one or more modules of computer program instructions, encoded on one or more non-transitory computer storage mediums for execution by, or to control the operation of, data processing apparatuses. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, a computer storage medium is tangible.

Various operations described in this specification can be implemented as operations performed by a data processing apparatus on data stored on one or more computer-readable storage devices or received from other sources.

The term “data processing apparatus” or “computing device” encompasses all kinds of apparatuses, devices, and machines for processing data, including by way of example a programmable processor, a computer, a system on a chip, or multiple ones, or combinations, of the foregoing. An apparatus can include special purpose logic circuitry, e.g., an FPGA (field programmable gate array) or an ASIC (application-specific integrated circuit). An apparatus can also include, in addition to hardware, code that creates an execution environment for a computer program, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. A processor and a memory can be supplemented by, or incorporated in, special purpose logic circuitry.

To provide for interaction with a user, various implementations can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Various implementations can be carried out using computing systems that include a back-end component, e.g., as a data server, or that include a middleware component, e.g., an application server, or that include a front-end component, e.g., a client computer having a graphical user interface or a web browser, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks). In various embodiments, one or more computer readable storage mediums store one or more computer programs that when executed on one or more computing systems cause the computing systems to perform the methods as disclosed in the Figures herein.

Computing systems can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination in a single implementation. Conversely, various features that are described in the context of a single implementation can also be carried out in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that various described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
presenting a user with a selectable option to either allow or disallow background downloads by applications running on a user device;
receiving a selection from the user that indicates whether to allow or disallow the background downloads by the applications running on the user device;
receiving, by a network operator system, a request from the user device for a network connection; and
providing, from the network operator system to the user device if the user has selected to disallow the background downloads, an Internet Protocol (IP) address of a Domain Name System (DNS) server that is specially configured to block background downloads.

2. The method of claim 1, further comprising:
providing, from the network operator system to the user device if the user has selected to allow the background downloads, an IP address of a normal DNS server that allows background downloads.

3. The method of claim 1, further comprising:
providing, by an application running on the user device, a hostname for a background update; and
sending, from the user device to the DNS server identified by the IP address, a DNS query for an IP address associated with the hostname.

4. The method of claim 3, further comprising:
determining, by the DNS server, whether the hostname is on a blacklist of hostnames;
sending, from the DNS server to the user device if it is determined that the hostname is on the blacklist of hostnames, an IP address of a specific server that is configured to reject connections; and
sending, from the DNS server to the user device if it is determined that the hostname is not on the blacklist of hostnames, an IP address of a server associated with the hostname.

5. The method of claim 4, further comprising:
sending a connection request from the user device to the IP address returned by the DNS server; and
rejecting the connection request by the specific server if the connection request is made to the specific server.

6. A system, comprising:
a server configured to reject connections; and
a Doman Name System (DNS) server configured to receive a DNS query for an Internet Protocol (IP) address associated with a hostname, and configured respond to the DNS query with an IP address of the server if the hostname is on a blacklist of hostnames.

7. The system of claim 6, further comprising:
an account management web server configured to receive a selection from a user that indicates whether to allow or disallow background downloads by applications running on a user device, and configured to inform a network provider server as to the selection made by the user.

8. The system of claim 6, further comprising:
a network provider server configured to receive information as to whether a user has selected to allow or disallow background downloads by applications running on a user device, and configured to receive a request from the user device for a network connection, and configured to send an IP address of the DNS server to the user device in response to the request for the network connection if the user has selected to disallow background downloads.

9. The system of claim 8, further comprising:
a second DNS server configured to respond to each DNS query having a specified hostname with the corresponding IP address for the specified hostname;
the network provider server configured to send an IP address of the second DNS server to the user device in response to the request for the network connection if the user has selected to allow background downloads.

10. The system of claim 6,
the DNS server configured to respond to the DNS query with an IP address corresponding to the hostname if the hostname is not on the blacklist of hostnames.

11. A method, comprising:
installing a local proxy with a default list of blacklisted domains and a metered connection list of networks on a user device; and
configuring local browsers and applications on the user device to send and receive traffic through the local proxy.

12. The method of claim 11, further comprising:
allowing a user to update the blacklist and metered connection list;
presenting the user with an option to be prompted to allow a connection if it is to a domain on the blacklist; and
receiving input from a user indicating whether the user has selected to be prompted.

13. The method of claim 11, further comprising:
receiving, by the local proxy from a local browser or application, a request for a connection to a domain;
determining, by the local proxy, if the user device is connected to a network that is on the metered connection list; and
enabling, by the local proxy, a connection to the domain if it is determined that the network is not on the metered connection list.

14. The method of claim 13, further comprising:
determining, by the local proxy, whether the domain is listed on the blacklist.

15. The method of claim 14, further comprising:
enabling, by the local proxy, a connection to the domain if it is determined that the domain is not on the blacklist.

16. The method of claim 14, further comprising:
blocking, by the local proxy, a connection to the domain if it is determined that the domain is on the blacklist and if it is determined that the network is on the metered connection list.

17. The method of claim 14, further comprising:
prompting, by the local proxy, a user to allow the user to select whether to allow a connection if it is determined that the domain is on the blacklist;
enabling the connection if the user selects to allow the connection; and
blocking the connection if the user selects to not allow the connection.

18. The method of claim 14, further comprising:
throttling, by the local proxy, a connection to the domain if it is determined that the domain is on the blacklist and if it is determined that the network is on the metered connection list.

19. The method of claim 14, further comprising:
prompting, by the local proxy, a user to allow the user to select whether to throttle a connection if it is determined that the domain is on the blacklist;
enabling the connection without throttling if the user selects to not throttle the connection; and
throttling the connection if the user selects to throttle the connection.

20. The method of claim 13, further comprising:
determining, by the local proxy, whether the request for the connection is for downloading a file of a blacklisted file type; and
blocking, by the local proxy, a connection to the domain if it is determined that the request for the connection is for downloading a file of a blacklisted file type and if it is determined that the network is on the metered connection list.

21. The method of claim 13, further comprising:
determining, by the local proxy, whether the request for the connection is for downloading a file of a type that is blacklisted for the domain; and
blocking, by the local proxy, a connection to the domain if it is determined that the request for the connection is for downloading a file of a type that is blacklisted for the domain and if it is determined that the network is on the metered connection list.

22. The method of claim 13, further comprising:
determining, by the local proxy, whether a certain traffic threshold has been achieved in a specified time period by the user device; and
blocking, by the local proxy, a connection to the domain if it is determined that the certain traffic threshold has been achieved in the specified time period by the user device and if it is determined that the network is on the metered connection list.
